(19) United States
(12) Patent Application Publication
(10) Pub. No.: US 2005/0122348 A1
(43) Pub. Date: Jun. 9, 2005

(54) Screen for displaying a menu in the form of graphics

(76) Inventor: Jerome Augui, Meudon (FR)

Correspondence Address: PHILIPS INTELLECTUAL PROPERTY & STANDARDS, P.O. BOX 3001, BRIARCLIFF MANOR, NY, 10510, US

(21) Appl. No.: 10/507,331

(22) PCT Filed: Mar. 3, 2003
(86) PCT No.: PCT/IB03/00877

(30) Foreign Application Priority Data
Mar. 15, 2002 (FR) 0203230

(51) Int. Cl. G09G 5/00

(52) U.S. Cl. 345/684

(57) ABSTRACT

The graphics shown on the screen (20) define a menu in which the items can be modified by the user. These graphics are disposed in a matrix block so that, by pressing a single key on the navigation pad (15), it is possible to select one of them from amongst a plurality. Application to portable telephones.

The present invention relates to an electronic apparatus comprising:
a screen for displaying a plurality of graphics,
scrolling means for changing the location of said graphics under the control of a control means.

The invention also relates to a method for displaying graphics illustrating in particular a menu of headings intended for the configuration of the apparatus by the user.

Such apparatus is well known and finds many applications, in particular in the field of portable telephones. In this regard reference may be made to patent document EP 0 944 218 (carrousel).

This apparatus, which gives complete satisfaction, does however require several presses for reaching a heading in a menu.

The present invention proposes an apparatus of the type mentioned in the preamble in which provision has been made for an organization of the graphics and means of changing graphics which require fewer presses on a change command whilst procuring a pleasant appearance for the user.

For this purpose, such an apparatus is characterized in that the graphics are disposed in a main-level matrix block and in that, by means of a single command, one of these graphics may be selected.

The method proposed by the invention is characterized in that it comprises the following steps:
disposing the graphics in a main-level matrix block,
allocating a control key for selecting one of said graphics amongst more than two,
activating a graphics area for activated graphics of a first type,
deployment of a block of graphics for an activated graphic of a second type.

The idea of the invention is to place the various graphics representing headings in a menu in a paved area (matrix) so that it is easy to pass from one box to another.

The invention will be further described with reference to examples of embodiments shown in the drawings to which, however, the invention is not restricted.

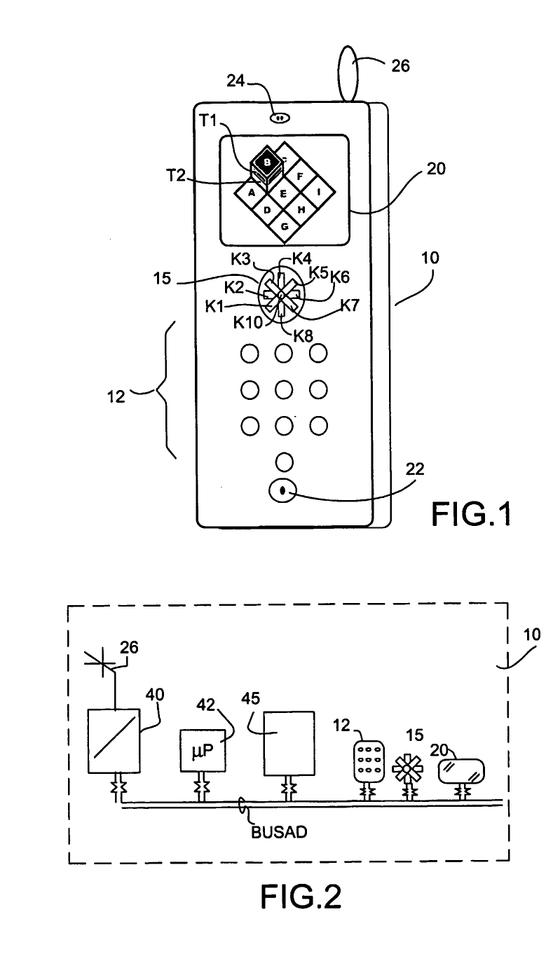

FIG. 1 shows an apparatus according to the invention.

FIG. 2 shows an electrical diagram of this apparatus.

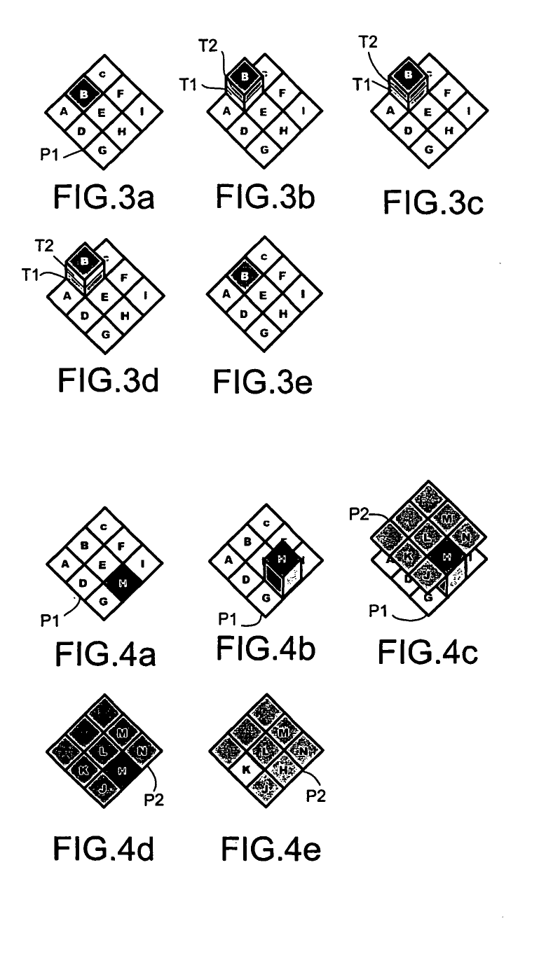

FIG. 3 shows the behavior of graphics of the so-called first type.

FIG. 4 shows the behavior of graphics of a so-called second type.

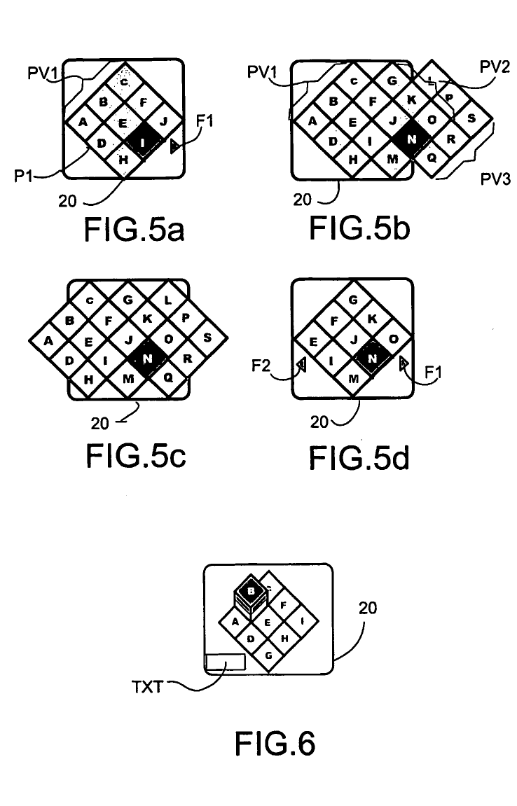

FIG. 5 shows an embodiment for a set of blocks whose visible dimensions are greater than the size of the screen.

FIG. 6 shows a screen in which a text area is incorporated.

FIG. 1 depicts an electronic apparatus according to the invention. In the context of the example described, it is a portable telephone apparatus that may be connected to a cellular network. It is composed of a casing 1 on which various elements are disposed. Among these elements are a keypad 12, a navigation pad 15 comprising various contacts K1, K2, K3, . . . K8 and K10, a screen 20, a microphone 22, a speaker 24 and an antenna 26. On the screen 20 various graphics are shown and bear the references A, B, C, D, E, F, G, H and I.

FIG. 2 shows how the apparatus is produced. The elements common with those in the previous figure bear the same references. The high-frequency signals picked up or transmitted by the antenna 26 are processed by a transmission/reception assembly 40. The functioning of this assembly 40 is governed by control signals conveyed over a common line BUSAD, produced by means of a microprocessor assembly 42. This assembly 42 uses a memory assembly 45 in which instructions defining its functioning are recorded. In this assembly there are contained random access memory locations necessary for the use of these instructions. The instructions used by the invention are obviously contained in this assembly 45. Thus it is possible to vary the appearance of the menus displayed on the screen 20 by acting on the navigation pad 18 and, if necessary, on the keypad 12.

According to the invention, the graphics A, B, C, D, E, F, G, H and I are disposed in a matrix block placed on a so-called main-level plane P1. This is seen in perspective. By means of a single command, one of these graphics may be selected. When the menu appears, represented by the block in question, operating one of the navigation keys selects one of the items in the menu. Thus pressing the key K1 enables the graphic D, pressing the key K2, the graphic A, pressing the key K3, the graphic B, pressing the key K4, the graphic C, pressing the key K5, the graphic E, pressing the key K6, the graphic I, pressing the key K7, the graphic H and finally pressing the key K8, the graphic G.

Once one of the graphics has been selected, it shows the choice for parameter values. In FIG. 1 the number of values which may be taken by the parameters represented by the graphic B is two, which is shown by two slices T1 and T2 stacked in a column. This type of graphic is referred to as the first type.

FIG. 3 shows, in more detail, how the user can configure his apparatus using measures recommended by the invention. At “a” in FIG. 3 the shaded graphic is the one which is selected as indicated above. At “b” the column appears showing its two slices T1 and T2, by pressing the key K10 at the center of the navigation pad. By pressing on one of the keys of the pad 15 the user can change the value of the parameter represented by the slice T1. This slice T1 is then shown shaded at “c”. In the same way he can change the value of the parameter represented by the slice T2. This changes to white at “d”. It goes without saying that any change in color, if the screen allows display in colors, comes within the scope of the invention. By pressing on the key K10 the column is erased (see “e”) and returns to the state shown at “a”. The graphics may also be of a second type, as is the case with the graphic H.

Referring to FIG. 4, at “a” the graphic H is selected. The column relating to this graphic is shown at “b” but, instead of presenting slices relating to the parameters, it shows at “c” another block situated on another plane P2 seen in perspective. The plane P1 is erased in order to reveal only the plane P2 on which there are disposed graphics J, K, L, M and N other than the graphic H at “d”. From this plane P2, it is then possible to select another graphic, K for example (see “e”).

It goes without saying that it is possible to juxtapose various blocks PV1, PV2, PV3 on the same plane. The screen 20 makes it possible to see only some of these blocks. This is what is shown in FIG. 5. At “a” the first block PV1 is shown, disposed on the plane P1. An arrow F1 displayed on the screen 20 indicates that other graphics are available to the user when the latter has selected a graphic contiguous with another block. By pressing on a key of the navigation pad 15, the blocks will move in a direction opposite to that indicated by the arrow F1. This is shown at “b” and at “c”. It may be considered that two other blocks PV2 and PV3 are in play. After selection of a graphic N belonging to the block PV2, this alone is shown on the screen 20. A second arrow F2 indicates that other blocks are available to the left and the arrow F1 that others are still available to the right.

FIG. 6 shows a text area TXT which is inserted in the display of the screen 20. This text supplies commentaries on the graphics displayed. This enables the user to avoid ambiguities on the meaning of the graphics.

1. An electronic apparatus comprising:
a screen for displaying a plurality of graphics,
scrolling means for changing the location of said graphics under the control of a control means, characterized in that the graphics are disposed in a main-level matrix block and in that, by means of only one command, one of these graphics may be selected.

2. An electronic apparatus as claimed in claim 1, characterized in that the plurality of graphics comprise at least one graphic of a first type representing various options of the apparatus.

3. An electronic apparatus as claimed in claim 1, characterized in that the plurality of graphics comprises at least one graphic of a second type representing graphics disposed in a secondary-level block.

4. An electronic apparatus as claimed in claim 1, characterized in that the graphics of the first type comprise areas corresponding to a parameter value.

5. An electronic apparatus as claimed in claim 1, characterized in that the block is shown in perspective on a first plane whilst the graphics of the first type are shown in another plane.

6. An electronic apparatus as claimed in claim 1, characterized in that the block is shown in perspective on a first plane whilst the graphics of the second type are disposed in a block parallel to the first plane.

7. An electronic apparatus as claimed in claim 1, characterized in that the graphics of the first type are in the form of a stack of slices forming a column of slices whose appearance changes according to the value which is given to the parameters which they represent.

8. An electronic apparatus as claimed in claim 1, characterized in that a text area concerning the graphics displayed on the screen is provided.

9. A method for displaying graphics used in an apparatus provided with a screen as claimed in claim 1, characterized in that it comprises the following steps:
arranging graphics in a main-level matrix block,
allocating a control key for selecting one of said graphics amongst more than two,
activating a graphics area for activated graphics of a first type,
deployment of a block of graphics for an activated graphic of a second type.
